(19) United States
(12) Patent Application Publication
(10) Pub. No.: US 2012/0089957 A1
(43) Pub. Date: Apr. 12, 2012

(54) CIRCUIT DESIGN ASSISTING DEVICE, METHOD AND COMPUTER-READABLE STORAGE MEDIUM

(75) Inventor: Shuichi YOSHIZAWA, Kawasaki (JP)

(73) Assignee: FUJITSU LIMITED, Kawasaki-shi (JP)

(21) Appl. No.: 13/237,670

(22) Filed: Sep. 20, 2011

(30) Foreign Application Priority Data
Oct. 12, 2010 (JP) 2010-229752

(51) Int. Cl. G06F 17/50

(52) U.S. Cl. 716/106

(57) ABSTRACT

A circuit design assisting device for assisting design of a circuit, the circuit design assisting device includes a storage unit that stores circuit connection data of the circuit, a selecting unit that chooses a storage element that holds a signal inputted from an input terminal based on a clock signal and outputs the signal from an output terminal from the circuit connection data, a tracing unit that traces a logical connection from the input terminal of the chosen storage element in an opposite direction against propagation of the signal based on the circuit connection data, and a control unit that suspends the tracing unit to trace the logical connection when the tracing unit reaches to an element having two or more input terminals.

### CROSS-REFERENCE TO RELATED APPLICATIONS

This application is based upon and claims priority to prior Japanese Patent Application No. 2010-229752 filed on Oct. 12, 2010 in the Japan Patent Office, the entire contents of which are incorporated herein by reference.

### FIELD

The present invention relates to a circuit design assisting device, a method for controlling a circuit design assisting device and a storage medium in which a program for controlling a circuit design assisting device is stored.

### BACKGROUND

A method for checking whether a synchronization signal such as a clock or reset signal in a net list which is connection data (circuit connection data or logical connection data) among terminals in a circuit is correctly connected in design of a semiconductor integrated circuit such as an LSI (Large Scale Integrated circuit) is known.

A method for checking connection of a synchronization signal for settling a synchronized path, e.g., by tracing a signal back from a synchronization signal input terminal of a flip-flop or a latch circuit so as to reach an external input terminal or a supplying or oscillating source of the synchronization signal such as a PLL (Phase Locked Loop) is known.

A scale (degree of integration) of a semiconductor integrated circuit to be checked increases as technologies for semiconductor micromachining progress, and a net list grows in size in parallel.

Thus, there is a problem in that a computer is used for a long period when the check is used for the check on the net list running short of processing capability or memory size.

The invention is made in view of the above problem. An object of the invention is to provide a circuit design assisting device, a method for controlling a circuit design assisting device and a storage medium in which a program for controlling a circuit design assisting device is stored, which accelerates a check on circuit design. Related arts of a circuit design assisting device, a method for controlling a circuit design assisting device and a storage medium in which a program for controlling a circuit design assisting device is stored are disclosed in the patent documents listed below.

[Patent Document 1] Japanese Laid-open Patent Publication No. 2003-316843

[Patent Document 2] Japanese Laid-open Patent Publication No. 2004-96813

### SUMMARY

According to an aspect of the invention, a circuit design assisting device for assisting design of a circuit includes a storage unit that stores circuit connection data of the circuit, a selecting unit that chooses a storage element that holds a signal inputted from an input terminal based on a clock signal and outputs the signal from an output terminal from the circuit connection data, a tracing unit that traces a logical connection from the input terminal of the chosen storage element in an opposite direction against propagation of the signal based on the circuit connection data, and a control unit that suspends the tracing unit to trace the logical connection when the tracing unit reaches to an element having two or more input terminals.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an outline of a circuit design assisting device of a first embodiment;

FIG. 2 illustrates an example hardware constitution of a circuit design assisting device of a second embodiment;

FIG. 3 is a block diagram for illustrating functions of the circuit design assisting device;

FIG. 4 explains a trace process of a synchronization signal path data producing unit:

FIG. 5 is a flowchart for illustrating a process of each of portions of the circuit design assisting device of the second embodiment;

FIG. 6 specifically illustrates an example process of the synchronization signal path data producing unit;

FIG. 7 illustrates an example of synchronization signal path data;

FIG. 8 is a block diagram for illustrating functions of a circuit design assisting device of a third embodiment;

FIG. 9 is a flowchart for illustrating a process of each of portions of the circuit design assisting device of the third embodiment;

FIG. 10 is a flowchart for illustrating a process for producing a reduced net list;

FIG. 11 specifically explains an example process for producing a reduced net list; and

FIG. 12 specifically explains an example process of the synchronization signal path data producing unit.

### DESCRIPTION OF EMBODIMENTS

Embodiments will be explained in detail below with reference to the drawings.

A circuit design assisting device of an embodiment will be generally explained at first, and the embodiment will be explained more specifically, later.

### First Embodiment

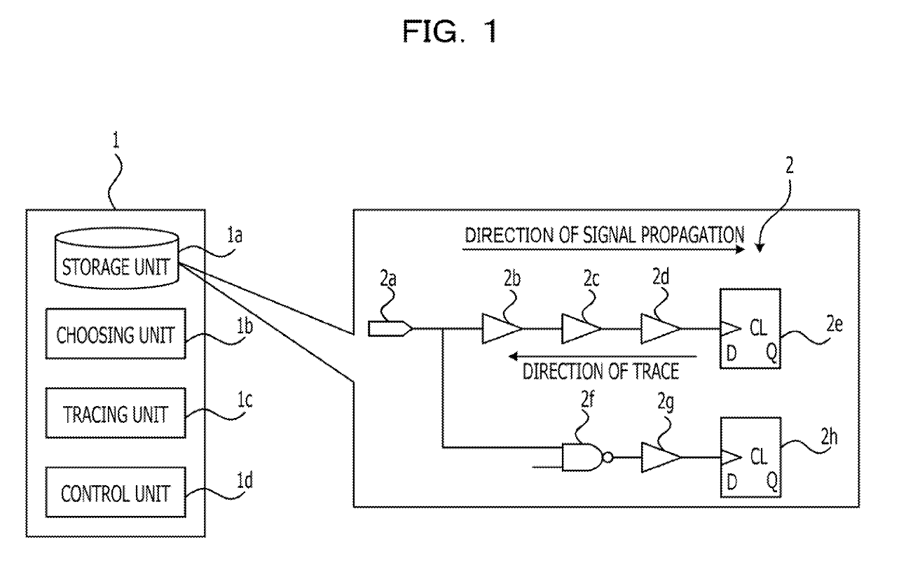

FIG. 1 illustrates an outline of a circuit design assisting device of a first embodiment.

The circuit design assisting device (computer) 1 of the embodiment has a storage unit 1a, a choosing unit 1b, a tracing unit 1c and a control unit 1d.

Circuit connection data (net list) of a circuit to be designed is stored in the storage unit 1a. The circuit connection data defines elements including, e.g., an AND circuit (logical product circuit) and connections among terminals of the elements.

FIG. 1 illustrates an example circuit embodied by the circuit connection data stored in the storage unit 1a.

The circuit connection data 2 includes data of a circuit in which a flip-flop 2e is connected to a reset terminal 2a via buffers 2b, 2c and 2d. Further, the circuit connection data 2 includes data of a circuit in which a flip-flop 2h is connected to the reset terminal 2a via a NAND circuit 2f and a buffer 2g.

The choosing unit 1b chooses, from the circuit connection data, a storage element which holds a signal inputted from an input terminal on the basis of a clock signal and outputs the signal from an output terminal. The storage element is, e.g., a flip-flop or a latch circuit.

In the circuit connection data 2 illustrated in FIG. 1, the choosing unit 1b chooses the flip-flops 2e and 2h.

The tracing unit 1c runs a trace on a logical connection on the basis of the circuit connection data from an input terminal of a chosen storage element in an opposite direction against signal propagation.

Further, if the tracing unit 1c runs a trace on the logical connection and the number of input terminals of an element reached owing to the trace is two or more, the control unit 1d stops the trace run by the tracing unit 1c.

As illustrated in FIG. 1, the tracing unit 1c runs a trace on a logical connection from an input terminal of the flip-flop 2e in an opposite direction against signal propagation. As a result, the reset terminal 2a is reached via the buffers 2d, 2c and 2b.

Further, the tracing unit 1c runs a trace on a logical connection from an input terminal of the flip-flop 2h in an opposite direction against signal propagation. As a result, the NAND circuit 2f is reached via the buffer 2g. As the number of input terminals of the NAND circuit 2f is two, the control unit 1d stops the trace.

If the number of input terminals of an element reached owing to a trace run on a logical connection of a chosen storage element is two or more, the control unit ld of the circuit design assisting device 1 stops the trace. A check on a portion which produces a synchronization signal is thereby prevented. As an area in which the synchronization signal of the circuit is checked is limited, unnecessary traces can be omitted. The circuit design can thereby be checked rapidly.

Incidentally, the choosing unit 1b, the tracing unit 1c and the control unit 1d can be implemented by functions of a CPU (Central Processing Unit) included in the circuit design assisting device 1. Further, the storage unit 1a can be implemented by a data storage area that a RAM (Random Access Memory), and a HDD (Hard Disk Drive), for example, included in the circuit design assisting device 1.

The embodiment will be more specifically explained below.

### Second Embodiment

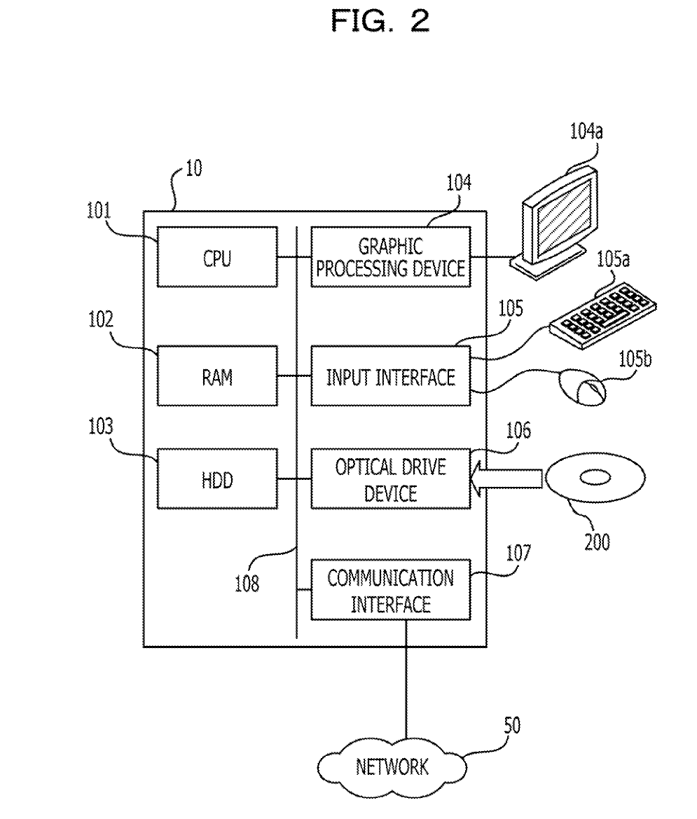

FIG. 2 illustrates an example hardware constitution of a circuit design assisting device of a second embodiment.

A CPU 101 controls the whole of a circuit design assisting device 10. A RAM 102 and a plurality of peripheral devices are connected to the CPU 101 via a bus 108.

The RAM 102 is used as a primary storage device of the circuit design assisting device 10. An OS (Operating System) program or at least some of application programs to be run by the CPU 101 is tentatively stored in the RAM 102. Further, various data necessary for a process run by the CPU 101 is stored in the RAM 102.

The peripheral devices connected to the bus 108 are a HDD 103, a graphic processing device 104, an input interface 105, an optical drive device 106, and a communication interface 107, for example.

The HDD 103 magnetically writes and reads data to and from a built-in disk. The HDD 103 is used as a secondary storage device of the circuit design assisting device 10. The OS program, the application programs and the various data are stored in the HDD 103. Incidentally, a semiconductor storage device such as a flash memory, etc. can be used as the secondary storage device.

A monitor 104a is connected to the graphic processing device 104. The graphic processing device 104 displays an image having been processed by the CPU 101 on a screen of the monitor 104a as instructed by the CPU 101. The monitor 104a is, e.g., an LCD (Liquid Crystal Display), for example.

A keyboard 105a and a mouse 105b are connected to the input interface 105. The input interface 105 transmits a signal received from the keyboard 105a or the mouse 105b to the CPU 101. Incidentally, the mouse 105b is an example pointing device, and other pointing devices can be used. Such other pointing devices are, e.g., a touch panel, a tablet, a touchpad, a trackball, etc.

The optical drive device 106 uses a laser beam, etc., so as to read data recorded on an optical disk 200. The optical disk 200 may be a removable recording medium on which data is recorded in such a way as to be read by a reflected light. The optical disk 200 is, e.g., a Blu-ray (registered trademark) disc, a DVD (Digital Versatile Disk), a DVD-RAM, a CD-ROM (Compact Disc Read Only Memory), a CD-R (Recordable)/RW (ReWritable), etc.

The communication interface 107 is connected to a network 50. The communication interface 107 transmits and receives data to and from another computer or a communication apparatus via the network 50.

Functions of the circuit design assisting device, a method for controlling the circuit design assisting device and a program for controlling the circuit design assisting device of the embodiment can be implemented by the aforementioned hardware constitution. The circuit design assisting device 10 having the above hardware constitution is provided inside with following functions.

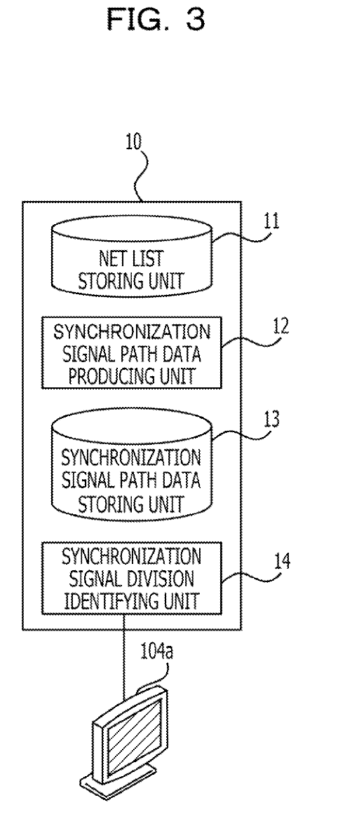

FIG. 3 is a block diagram for illustrating the circuit design assisting device.

The circuit design assisting device 10 has a net list storing unit 11, a synchronization signal path data producing unit 12, a synchronization signal path data storing unit 13 and a synchronization signal division identifying unit 14.

A net list (circuit connection data) produced as to a circuit to be designed is stored in the net list storing unit 11.

Incidentally, the net list storing unit 11 is placed in the circuit design assisting device 10 of the embodiment. The net list storing unit 11 is not limited to be placed in the circuit design assisting device 10 as described above, and can be placed out of the circuit design assisting device 10.

The synchronization signal path data producing unit 12 produces synchronization signal path data on the basis of a net list stored in the net list storing unit 11.

The synchronization signal path data producing unit 12 specifically carries out a trace process from a synchronization signal input terminal of every synchronized unit to be checked chosen as a trace starting point. The synchronized unit is an example storage element which holds a signal inputted from the input terminal on the basis of a clock signal and outputs the signal from an output terminal. That is, define the synchronized unit as a logic element such as a flip-flop or a latch circuit which is provided with an input value and changes an output value in synchronization with a change of a synchronization signal such as a clock signal. The synchronized unit excludes a logic element which changes an output value as an input value changes such as an AND circuit or an OR circuit. Further, a synchronized unit to be checked can be selected by, e.g., a designer's choice or the synchronization signal path data producing unit 12 choosing all synchronized units in a circuit which divides a produced synchronization signal.

In the trace process, the synchronization signal path data producing unit 12 runs a trace on a logical connection from a synchronization signal input terminal of a chosen synchronized unit in an opposite direction against signal propagation.

Upon an output terminal of a synchronized unit except for the chosen synchronized unit being reached, then, the synchronization signal path data producing unit 12 stores a trace result as synchronization signal path data in the synchronization signal path data storing unit 13. Further, upon two or more unsynchronized units being reached in the trace, the synchronization signal path data producing unit 12 stops the trace. Then, the synchronization signal path data producing unit 12 stores a trace result up to the portion on which the trace has been run as the synchronization signal path data in the synchronization signal path data storing unit 13. Incidentally, the unsynchronized unit may be, e.g., an AND (logical product) circuit, an OR (logical sum) circuit, a buffer or an inverter.

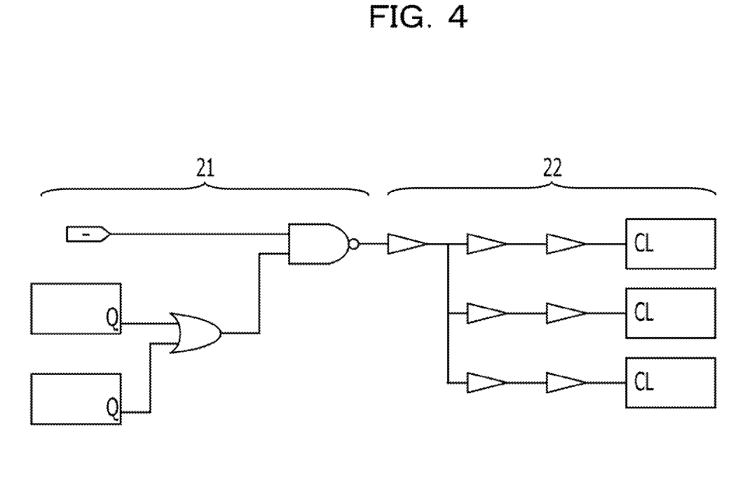

FIG. 4 illustrates the trace process of the synchronization signal path data producing unit.

The circuit to be designed has a portion 21 which produces a synchronization signal and a portion 22 which divides a produced synchronization signal.

Upon an output terminal of a synchronized unit except for the chosen synchronized unit being reached in a trace, the synchronization signal path data producing unit 12 stops the trace so as not to check the portion 21. In other words, the synchronization signal path data producing unit 12 primarily checks a dividing circuit having a buffer (buffering circuit) or an inverter (inverting circuit) as a logic element. An unnecessary trace may thereby be omitted so that the check on synchronization signal connections can be accelerated. A plurality of buffers and inverters put in a circuit are each called a “repeater” as well hereafter.

As a buffer propagates a received signal without changing polarity of a received signal, the number of buffers to be put as repeaters need not be paid attention to as to the polarity of the propagated signal. Meanwhile, as the inverter propagates a received signal while inverting the polarity of the signal, it should be paid attention to that the number of inverters to be put as repeaters needs to be even so as to maintain the polarity of the propagated signal.

At this time, the synchronization signal path data producing unit 12 counts the number of the inverters having been reached in the trace process for each of the synchronization signal path data. Then, the synchronization signal path data producing unit 12 stores, in the synchronization signal path data storing unit 13, synchronization signal path data in which a counted result is set.

Returning to FIG. 3 and continuing the explanation thereof.

The synchronization signal division identifying unit 14 identifies whether propagation and division of a synchronization signal is correct or not on the basis of the synchronization signal path data.

Then, the synchronization signal division identifying unit 14 identifies, on the basis of the counted result set in each of the synchronization signal path data, whether a signal having passed a propagation path or a division path of a synchronization signal included in the synchronization signal path data reaches an output terminal of a synchronized unit or a synchronization signal output line on which the relevant synchronization signal is outputted in the same signal polarity that the relevant synchronization signal was produced in.

If, e.g., the relevant synchronization signal is produced in the positive polarity (positive logic) (+), and reaches an output terminal of a synchronized unit or a synchronization signal output line in the positive polarity (positive logic) (+), the synchronization signal division identifying unit 14 identifies that the synchronization signal is correctly propagated or divided. Further, if the relevant synchronization signal is produced in the negative polarity (negative logic) (−), and reaches an output terminal of a synchronized unit or a synchronization signal output line in the negative polarity (negative logic) (−), the synchronization signal division identifying unit 14 identifies that the synchronization signal is correctly propagated or divided.

Further, the synchronization signal division identifying unit 14 displays a synchronization signal identified result on the monitor 104a.

The synchronization signal division identifying unit 14, e.g., checks if a synchronization signal of every path on which a trace is run identified by the synchronization signal path data has reached an output terminal of a synchronized unit or a synchronization signal line on which the relevant synchronization signal is outputted in the same signal polarity that the relevant synchronization signal was produced in. If the synchronization signal of every path has reached the output terminal or the synchronization signal line in the same signal polarity that the relevant synchronization signal was produced in, the synchronization signal division identifying unit 14 displays a message that the synchronization signal of the circuit to be checked is correctly connected on the monitor 104a. Further, if a signal of a path on which the signal does not reach the output terminal or the synchronization signal line in the same signal polarity that the relevant synchronization signal was produced in exists, the synchronization signal division identifying unit 14 displays the signal of the path on the monitor 104a.

Then, a process of each of the portions of the circuit design assisting device 10 will be explained.

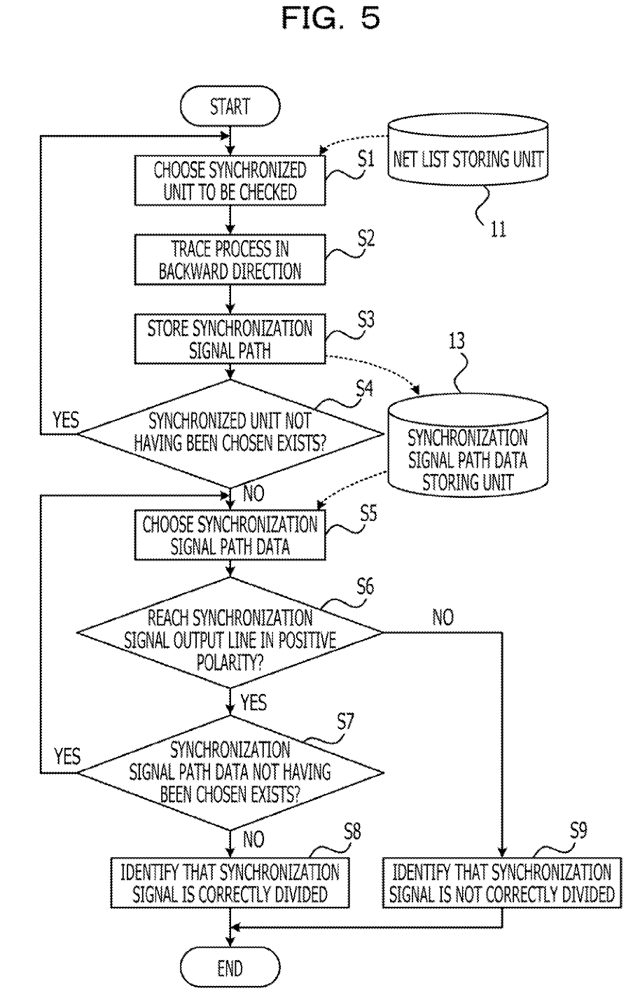

FIG. 5 is a flowchart for illustrating a process of each of the portions of the circuit design assisting device 10 of the second embodiment.

(Step S1) The synchronization signal path data producing unit 12 chooses one synchronized unit to be checked not having been chosen on the basis of a net list stored in the net list storing unit 11. Then, move on to a step S2.

(Step S2) The synchronization signal path data producing unit 12 runs a trace for the synchronized unit to be checked chosen at the step S1 from a synchronization signal input terminal of the synchronized unit in a backward direction. Upon the trace being finished, move on to a step S3.

(Step S3) The synchronization signal path data producing unit 12 stores produced synchronization signal path data in the synchronization signal path data storing unit 13. Then, move on to a step S4.

(Step S4) The synchronization signal path data producing unit 12 identifies whether the net list storing unit 11 includes a synchronized unit not having been chosen. If a synchronized unit not having been chosen is included (Yes of the step S4), move on to the step S1. If no synchronized unit not having been chosen is included (No of the step S4), move on to a step S5.

(Step S5) The synchronization signal division identifying unit 14 chooses one of the synchronization signal path data stored in the synchronization signal path data storing unit 13. Then, move on to a step S6.

(Step S6) The synchronization signal division identifying unit 14 identifies whether a signal having passed a synchronized path included in the synchronization signal path data chosen at the step S5 reaches an output terminal of a synchronized unit or a synchronization signal output line on which the relevant synchronization signal is outputted in the same signal polarity that the relevant synchronization signal was produced in. If the signal reaches a synchronization signal output line in the positive polarity (Yes of the step S6), move on to a step S7. If the signal does not reach an output terminal of a synchronized unit or a synchronization signal output line in the same signal polarity that the relevant synchronization signal was produced in (No of the step S6), move on to a step S9. Incidentally, if the synchronization signal path data includes no synchronization signal output line, move on to the step S9 as well.

(Step S7) The synchronization signal division identifying unit 14 identifies whether synchronization signal path data not having been chosen exists. If synchronization signal path data not having been chosen exists (Yes of the step S7), move on to the step S5. Then, the synchronization signal division identifying unit 14 chooses one of the synchronization signal path data not having been chosen and continues the process following the step S6. If no synchronization signal path data not having been chosen exists (No of the step S7), move on to a step S8.

(Step S8) The synchronization signal division identifying unit 14 identifies that a synchronization signal is correctly propagated on or divided into the synchronized path included in the synchronization signal path data chosen at the step S5. Then, the synchronization signal division identifying unit 14 displays an identified result on the monitor 104a. Then, the process illustrated in FIG. 5 ends.

(Step S9) The synchronization signal division identifying unit 14 identifies that a synchronization signal is not correctly propagated on or divided into the synchronized path included in the synchronization signal path data chosen at the step S5. Then, the synchronization signal division identifying unit 14 displays an identified result on the monitor 104a. Then, the process illustrated in FIG. 5 ends.

Incidentally, the process illustrated in FIG. 5 ends at the time when the synchronization signal division identifying unit 14 identifies that a synchronization signal is not correctly propagated or divided in the process illustrated in FIG. 5. When the process ends is not limited to the aforementioned above, though, and the synchronization signal division identifying unit 14 may display the identified result on the monitor 104a after carrying out the process at the step S6 for all the synchronization signal path data, and then end the process.

Then, an example process of the synchronization signal path data producing unit 12 will be explained.

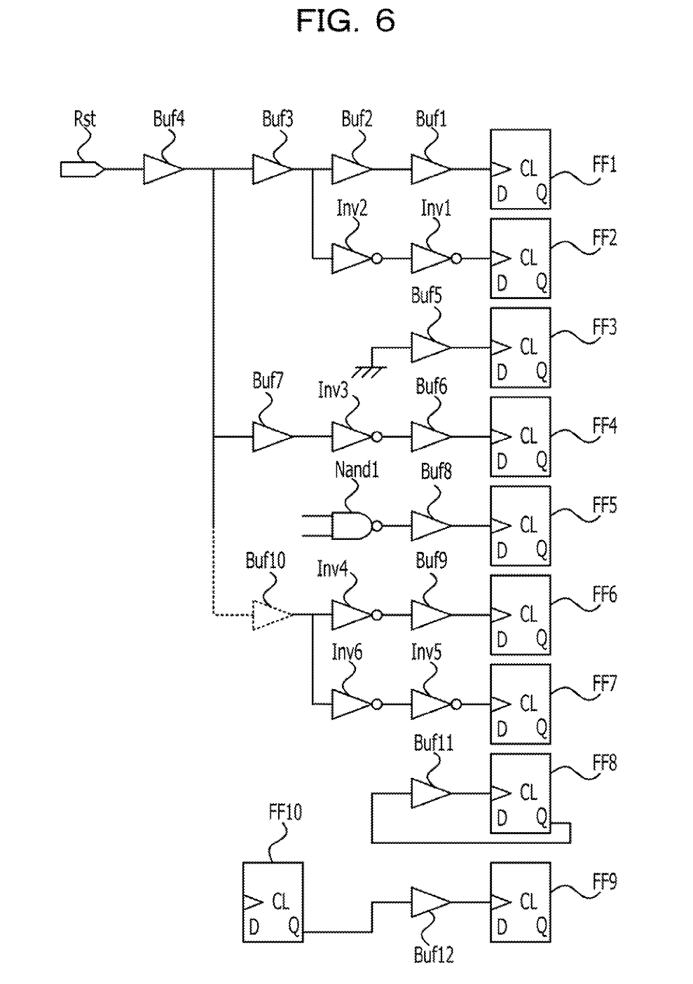

FIG. 6 specifically illustrates an example process of the synchronization signal path data producing unit.

A signal inputted from a reset terminal Rst illustrated in FIG. 6 is a synchronization signal that a signal inputted from an external input terminal or a signal produced by a circuit which produces a synchronization signal of the portion 21 illustrated in FIG. 4, e.g., is divided into. A wire connected to the output terminal of the reset terminal Rst is the synchronization signal output line illustrated in FIG. 6.

In FIG. 6, the synchronization signal path data producing unit 12 chooses flip-flops FF1-FF9 as all synchronized units to be checked.

If the synchronization signal path data producing unit 12 runs a trace on the connection in a direction from a clear (CL) terminal which is an input terminal of the flip-flop FF1 to the reset terminal Rst, buffers Buf1, Buf2, Buf3 and Buf4 are passed and the reset terminal Rst is reached. The synchronization signal path data producing unit 12 produces synchronization signal path data regarding the path from the flip-flop FF1 to the reset terminal Rst.

If the synchronization signal path data producing unit 12 runs a trace on the connection in a direction from a clear (CL) terminal which is an input terminal of the flip-flop FF2 to the reset terminal Rst, inverters Inv1 and Inv2 and the buffers Buf3 and Buf4 are passed, and the reset terminal Rst is reached. The synchronization signal path data producing unit 12 produces synchronization signal path data regarding the path from the flip-flop FF2 to the reset terminal Rst.

If the synchronization signal path data producing unit 12 runs a trace on the connection in a direction from a clear (CL) terminal which is an input terminal of the flip-flop FF3 to the reset terminal Rst, the traced path is grounded after a buffer Buf5 is passed and the reset terminal Rst is not reached. Thus, the synchronization signal path data producing unit 12 produces synchronization signal path data regarding the path from the flip-flop FF3 to GND.

If the synchronization signal path data producing unit 12 runs a trace on the connection in a direction from a clear (CL) terminal which is an input terminal of the flip-flop FF4 to the reset terminal Rst, a buffer Buf6, an inverter Inv3 and buffers Buf7 and Buf4 are passed, and the reset terminal Rst is reached. The synchronization signal path data producing unit 12 produces synchronization signal path data regarding the path from the flip-flop FF4 to the reset terminal Rst.

If the synchronization signal path data producing unit 12 runs a trace on the connection in a direction from a clear (CL) terminal which is an input terminal of the flip-flop FF5 to the reset terminal Rst, a buffer Buf8 is passed and a NAND circuit Nand1 is reached. As the element reached owing to the trace is a NAND circuit which is a logic element other than the repeaters, the synchronization signal path data producing unit 12 stops the trace. Then, the synchronization signal path data producing unit 12 produces synchronization signal path data regarding the path from the flip-flop FF5 to the NAND circuit Nand1.

Even if one of input terminals of the NAND circuit Nand1 is connected to the reset terminal Rst in this case, the synchronization signal path data producing unit 12 stops the trace as another signal is connected to another input terminal of the NAND circuit Nand1.

If the synchronization signal path data producing unit 12 runs a trace on the connection in a direction from a clear (CL) terminal which is an input terminal of the flip-flop FF6 to the reset terminal Rst, the signal line is broken after a buffer Buf9 and an inverter Inv4 are passed. A buffer Buf10 and a signal line connecting the buffer Buf10 to the buffer Buf4 indicated by dotted lines in FIG. 6 represent a portion lacking in wiring as lacking a particular layer whose design is ongoing, etc. In such a case that a portion lacking in wiring is reached owing to the trace, the synchronization signal path data producing unit 12 stops the trace. Then, the synchronization signal path data producing unit 12 produces synchronization signal path data regarding the path from the flip-flop FF6 to the inverter Inv4. Further, upon tracing the connection in a direction from a clear (CL) terminal which is an input terminal of the flip-flop FF7 to the reset terminal Rst, the synchronization signal path data producing unit 12 produces synchronization signal path data regarding the path from the flip-flop FF7 to an inverter Inv6 as well similarly as upon tracing the connection in the direction from the clear terminal of the flip-flop FF6 to the reset terminal Rst.

If the synchronization signal path data producing unit 12 runs a trace on the connection in a direction from a clear (CL) terminal which is an input terminal of the flip-flop FF8 to the reset terminal Rst, a buffer Buf11 is passed and a Q-terminal which is an output terminal of the flip-flop FF8 is reached. As the element reached owing to the trace is a flip-flop which is a synchronized unit, the synchronization signal path data producing unit 12 stops the trace. Then, the synchronization signal path data producing unit 12 produces synchronization signal path data regarding the path from the clock terminal of the flip-flop FF8 to the Q-terminal of the flip-flop FF8.

If the synchronization signal path data producing unit 12 runs a trace on the connection in a direction from a clear (CL) terminal which is an input terminal of the flip-flop FF9 to the reset terminal Rst, a buffer Buf12 is passed and a Q-terminal which is an output terminal of the flip-flop FF10 is reached. As the element reached owing to the trace is a flip-flop which is a synchronized unit, the synchronization signal path data producing unit 12 stops the trace. Then, the synchronization signal path data producing unit 12 produces synchronization signal path data regarding the path from the clock terminal of the flip-flop FF9 to the Q-terminal of the flip-flop FF10.

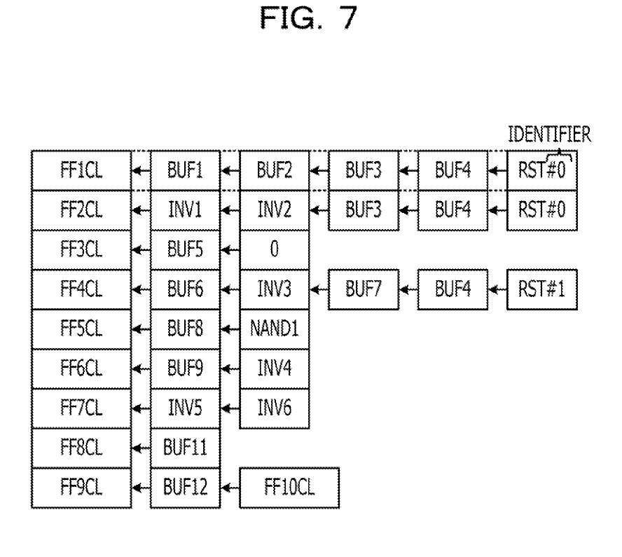

FIG. 7 illustrates an example of synchronization signal path data.

The synchronization signal path data illustrated in FIG. 7 indicates a result traced from the flip-flop FF1 on a first row. An entry FF1CL on the first row indicates the clear terminal which is the input terminal of the flip-flop FF1. Further, entries BUF1-BUF4 indicate the buffers Buf1-Buf4, respectively. An entry RST indicates the reset terminal Rst. Then, a symbol “#0” or “#1” following RST indicates an identifier (data for identification) to be set every time an input terminal of a buffer or an inverter is reached in accordance with a counted result of the number of the reached inverters. To put it specifically, the identifier “#0” is set if the number of the counted inverters is even. The identifier “#1” is set if the number of the counted inverters is odd.

To the synchronization signal path data on the first row in FIG. 7, e.g., the identifier “#0” is set as the number of the inverters existing on the synchronization signal path traced from the clear terminal which is the input terminal of the flip-flop FF1 is zero. Further, to the synchronization signal path data on the fourth row in FIG. 7, the identifier “#1” is set as the number of the inverters existing on the synchronization signal path traced from the clear terminal which is the input terminal of the flip-flop FF4 is one.

The synchronization signal path data includes the respective paths starting from the synchronization signal input terminals of the flip-flops FF1-FF9, so that a designer can easily check through which paths the synchronization signal path is traced by referring to the synchronization signal path data.

Then, an example process of the synchronization signal division identifying unit 14 will be specifically explained by the use of the synchronization signal path data illustrated in FIG. 7.

The synchronization signal division identifying unit 14 checks whether all the flip-flops FF1-FF9 are each provided with a synchronization signal propagated or divided in the same polarity that the relevant synchronization signal was produced in.

Specifically, at first, the synchronization signal division identifying unit 14 chooses the synchronization signal path data on the first row. As the identifier “#0” is set to the synchronization signal path data on the first row, the synchronization signal division identifying unit 14 identifies that the synchronization signal included in the synchronization signal path data on the first row reaches the synchronization signal output line from the reset terminal Rst in the same signal polarity. The synchronization signal division identifying unit 14 identifies that the flip-flop FF1 is provided with a signal divided from the reset terminal Rst in the same signal polarity.

Then, the synchronization signal division identifying unit 14 chooses the synchronization signal path data on the second row. As the identifier “#0” is set to the synchronization signal path data on the second row, the synchronization signal division identifying unit 14 identifies that the flip-flop FF2 is provided with a signal divided from the reset terminal Rst in the same signal polarity.

Next, the synchronization signal division identifying unit 14 chooses the synchronization signal path data on the third row. As the synchronization signal path data on the third row includes no RST, the synchronization signal division identifying unit 14 identifies that the flip-flop FF3 is provided with no signal divided from the reset terminal Rst.

Then, the synchronization signal division identifying unit 14 chooses the synchronization signal path data on the fourth row. As the identifier “#1” is set to the synchronization signal path data on the fourth row, the synchronization signal division identifying unit 14 identifies that the synchronization path included in the synchronization signal path data reaches the synchronization signal output line from the reset terminal Rst in the opposite signal polarity, e.g., after the signal polarity is inverted. The synchronization signal division identifying unit 14 identifies that the flip-flop FF4 is not provided with a signal divided from the reset terminal Rst in the same signal polarity.

Then, the synchronization signal division identifying unit 14 chooses the synchronization signal path data on the fifth row. As the synchronization signal path data on the fifth row includes no RST, the synchronization signal division identifying unit 14 identifies that the flip-flop FF5 is provided with no signal divided from the reset terminal Rst.

Then, the synchronization signal division identifying unit 14 chooses the synchronization signal path data on the sixth row. As the synchronization signal path data on the sixth row includes no RST, the synchronization signal division identifying unit 14 identifies that the flip-flop FF6 is provided with no signal divided from the reset terminal Rst.

Next, the synchronization signal division identifying unit 14 chooses the synchronization signal path data on the seventh row. As the synchronization signal path data on the seventh row includes no RST, the synchronization signal division identifying unit 14 identifies that the flip-flop FF7 is provided with no signal divided from the reset terminal Rst.

Then, the synchronization signal division identifying unit 14 chooses the synchronization signal path data on the eighth row. As the synchronization signal path data on the eighth row includes no RST, the synchronization signal division identifying unit 14 identifies that the flip-flop FF8 is provided with no signal divided from the reset terminal Rst.

Then, the synchronization signal division identifying unit 14 chooses the synchronization signal path data on the ninth row. As the synchronization signal path data on the ninth row includes no RST, the synchronization signal division identifying unit 14 identifies that the flip-flop FF9 is provided with no signal divided from the reset terminal Rst.

According to the circuit design assisting device 10, as described above, if the synchronization signal path data producing unit 12 runs a trace on a logical connection of a single-input logic element which is a repeater such as a buffer or an inverter and the number of input terminals of a reached element is two or more, the trace is stopped. A portion which produces a synchronization signal can thereby be prevented from being checked, and an area where a synchronization signal of a circuit is checked can be limited. As omitting an unnecessary trace, the circuit design assisting device 10 can promptly check whether a synchronization signal of a circuit to be designed is correctly connected.

Further, the synchronization signal division identifying unit 14 displays an identified result on the monitor 104a. A designer can thereby promptly find out an error or a conflict in polarity by checking the synchronization signal path data stored in the synchronization signal path data storing unit 13.

Incidentally, according to the embodiment, the synchronization signal path data producing unit 12 produces an identifier and the synchronization signal division identifying unit identifies on the basis of the identifier whether a synchronization signal reaches an output terminal of a synchronized unit or a synchronization signal output line on which the synchronization signal is outputted. Another configuration not limited to the above is conceivable, though, such that the synchronization signal division identifying unit 14 produces an identifier.

### Third Embodiment

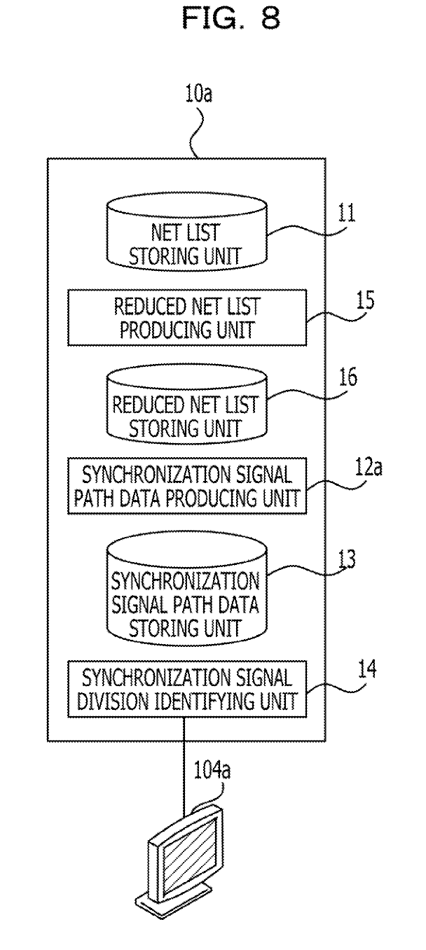

FIG. 8 is a block diagram for illustrating functions of the circuit design assisting device of the third embodiment.

A circuit design assisting device 10a of the third embodiment further has a reduced net list producing unit 15 and a reduced net list storing unit 16 as compared with the design assisting device 10. Further, the circuit design assisting device 10a has a synchronization signal path data producing unit 12a having functions partially different from those of the synchronization signal path data producing unit 12.

The reduced net list producing unit 15 excludes a logic element having two or more input terminals from a net list stored in the net list storing unit 11 so as to produce a reduced net list. Then, the reduced net list producing unit 15 stores the reduced net list produced above in the reduced net list storing unit 16.

The synchronization signal path data producing unit 12a produces data regarding a synchronization signal path on the basis of the reduced net list stored in the reduced net list storing unit 16.

Then, a process of each of the portions of the circuit design assisting device 10a of the third embodiment will be explained.

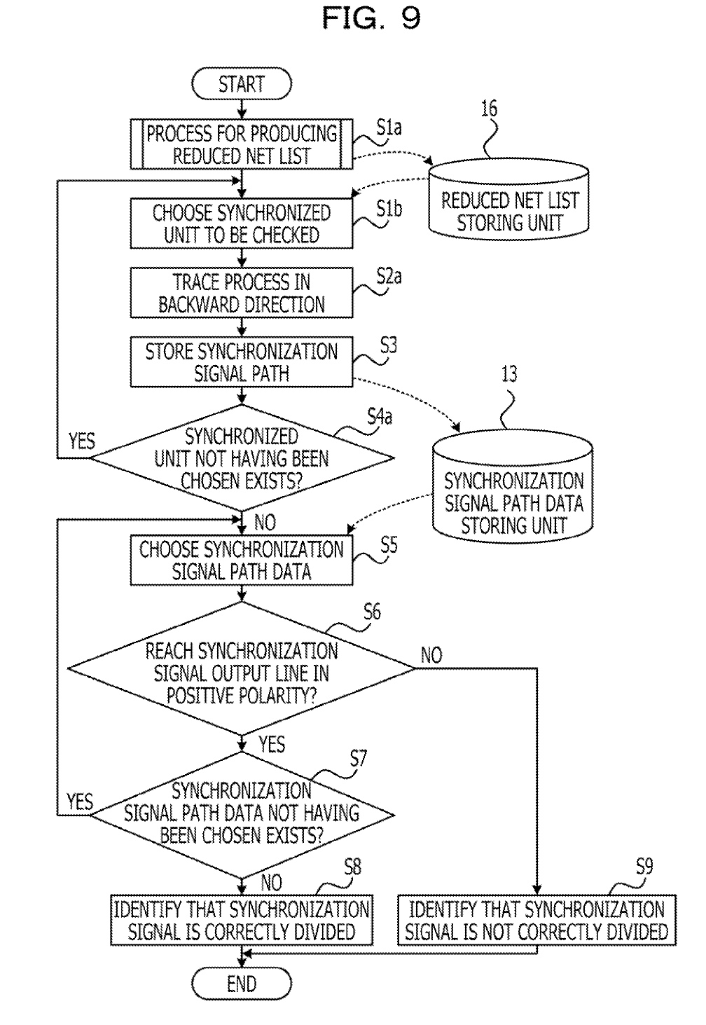

FIG. 9 is a flowchart for illustrating a process of each of the portions of the circuit design assisting device of the third embodiment. Incidentally, a step which is substantially the same as that of each of the portions of the second embodiment is given a same reference numeral for explanation.

(Step S1a) The reduced net list producing unit 15 produces a reduced net list. Incidentally, a process for producing a reduced net list will be explained later in detail. Then, the reduced net list producing unit 15 stores the produced reduced net list in the reduced net list storing unit 16. Then, move on to a step S1b.

(Step S1b) The synchronization signal path data producing unit 12 chooses one synchronized unit to be checked not having been chosen on the basis of the reduced net list stored in the reduced net list storing unit 16. Then, move on to a step S2a.

(Step S2a) The synchronization signal path data producing unit 12 runs a trace for the synchronized unit to be checked chosen at the step S1b from a synchronization signal input terminal of the synchronized unit in a backward direction. Upon the trace being finished, move on to a step S3.

(Step S3) The synchronization signal path data producing unit 12 stores produced synchronization signal path data in the synchronization signal path data storing unit 13. Then, move on to a step S4a.

(Step S4a) The synchronization signal path data producing unit 12 identifies whether the reduced net list storing unit 16 includes a synchronized unit not having been chosen. If a synchronized unit not having been chosen is included (Yes of the step S4a), move on to the step S1b. If no synchronized unit not having been chosen is included (No of the step S4a), move on to a step S5.

(Step S5) The synchronization signal division identifying unit 14 chooses one of the synchronization signal path data stored in the synchronization signal path data storing unit 13. Then, move on to a step S6.

(Step S6) The synchronization signal division identifying unit 14 identifies whether a signal having passed a synchronized path included in the synchronization signal path data chosen at the step S5 reaches an output terminal of a synchronized unit or a synchronization signal output line on which the relevant synchronization signal is outputted in the same signal polarity that the relevant synchronization signal was produced in. If the signal reaches a synchronization signal output line in the positive polarity (Yes of the step S6), move on to a step S7. If the signal does not reach an output terminal of a synchronized unit or a synchronization signal output line in the same signal polarity that the relevant synchronization signal was produced in (No of the step S6), move on to a step S9.

(Step S7) The synchronization signal division identifying unit 14 identifies whether synchronization signal path data not having been chosen exists. If synchronization signal path data not having been chosen exists (Yes of the step S7), move on to the step S5. Then, the synchronization signal division identifying unit 14 chooses one of the synchronization signal path data not having been chosen and continues the process following the step S6. If no synchronization signal path data not having been chosen exists (No of the step S7), move on to a step S8.

(Step S8) The synchronization signal division identifying unit 14 identifies that a synchronization signal is correctly propagated or divided. Then, the synchronization signal division identifying unit 14 displays an identified result on the monitor 104a. Then, ends the process illustrated in FIG. 9.

(Step S9) The synchronization signal division identifying unit 14 identifies that a synchronization signal is not correctly propagated or divided. Then, the synchronization signal division identifying unit 14 displays an identified result on the monitor 104a. Then, ends the process illustrated in FIG. 9.

Then, the process for producing a reduced net list at the step S1a will be explained.

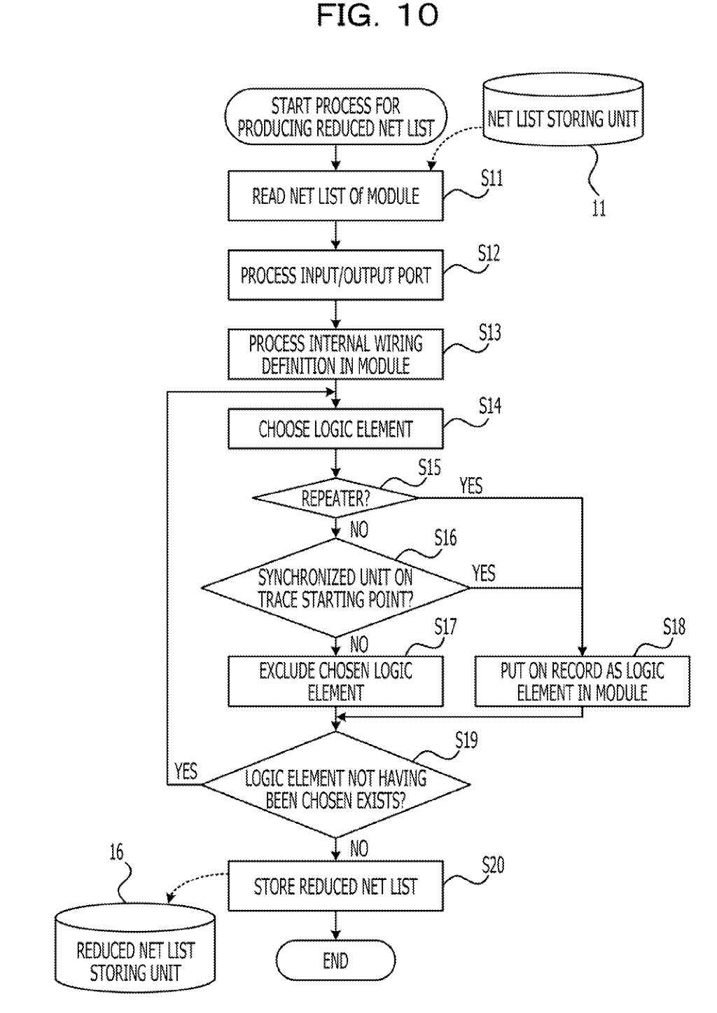

FIG. 10 is a flowchart for illustrating the process for producing a reduced net list.

(Step S11) The reduced net list producing unit 15 reads a net list of a module which is a design unit from a net list stored in the net list storing unit 11. Then, move on to a step S12.

(Step S12) The reduced net list producing unit 15 processes an input/output port (e.g., input, output) which is an input/output terminal on a module layer. Then, move on to a step S13.

(Step S13) The reduced net list producing unit 15 processes a property of internal wiring in the module (e.g., reg, wire). Then, move on to a step S14.

(Step S14) The reduced net list producing unit 15 chooses one logic element. Then, move on to a step S15.

(Step S15) The reduced net list producing unit 15 identifies whether the logic element chosen at the step S14 is a repeater such as a buffer or an inverter. If the chosen logic element is a repeater (Yes of the step S15), move on to a step S18. If the chosen logic element is not a repeater (No of the step S15), move on to a step S16.

(Step S16) The reduced net list producing unit 15 identifies whether the logic element chosen at the step S14 is a synchronized unit on a trace starting point. If the logic element chosen at the step S14 is a synchronized unit on a trace starting point (Yes of Step S16), move on to a step S18. If the logic element chosen at the step S14 is not a synchronized unit on a trace starting point (No of Step S16), move on to a step S17.

(Step S17) The reduced net list producing unit 15 excludes the logic element chosen at the step S14 from the net list. From the net list of the logic element, only instance data for identifying the logic element is excluded from the net list while connection data of a signal line connected to the logic element remains in the net list. Then, move on to a step S19.

(Step S18) The reduced net list producing unit 15 puts the logic element chosen at the step S14 on record on the reduced net list as a logic element in the module. Then, move on to a step S19.

(Step S19) The reduced net list producing unit 15 identifies whether another logic element exists. If another logic element exists (Yes of the step S19), move on to the step S14. If no other logic elements exist (No of the step S19), move on to a step S20.

(Step S20) The reduced net list producing unit 15 stores the reduced net list in the reduced net list storing unit 16. Then, ends the process illustrated in FIG. 10.

Then, an example process of the circuit design assisting device of the third embodiment will be specifically explained.

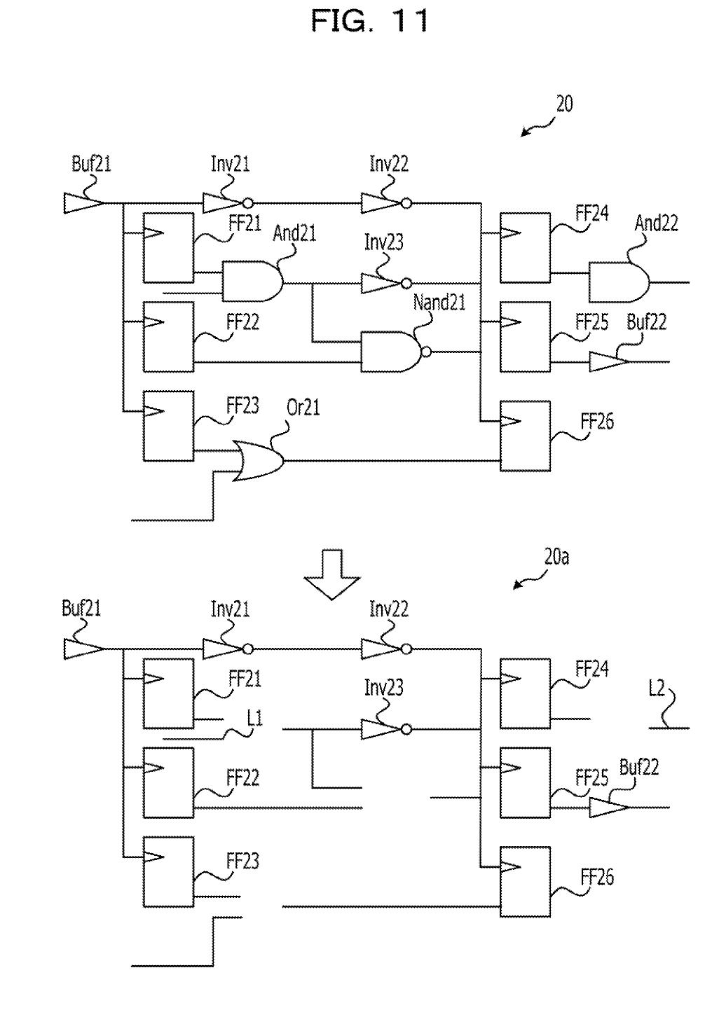

FIG. 11 specifically explains an example process for producing a reduced net list.

FIG. 11 illustrates example circuits 20 and 20a embodied by a net list stored in the net list storing unit 11 and by a reduced net list stored in the reduced net list storing unit 16, respectively.

The reduced net list excludes AND circuits And21 and And22, a NAND circuit Nand21 and an OR circuit Or21 which are not repeaters.

Incidentally, as only instance data for identifying a logic element to be excluded is excluded from the net list while connection data of a signal line connected to the logic element to be excluded remains in the net list according to the embodiment, a wire connected to nowhere remains in internal wiring data connected to the excluded logic element in the reduced net list. In FIG. 11, wires L1 and L2 having been connected to an input terminal of the AND circuit And 21 and to an output terminal of the AND circuit And22, respectively, remain in the reduced net list. How to deal with these wires is not limited to the above, though, and the wires L1 and L2 may be removed.

Next, an example process of the synchronization signal path data producing unit 12a of the third embodiment will be specifically explained.

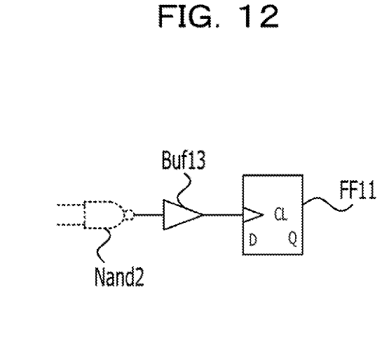

FIG. 12 specifically explains an example process of the synchronization signal path data producing unit.

The specific example illustrated in FIG. 12 illustrates a new case which occurs upon a reduced net list being made in addition to the specific example illustrated in FIG. 6.

If the synchronization signal path data producing unit 12a runs a trace on the connection in a direction from a clear (CL) terminal which is an input terminal of the flip-flop FF11 to the reset terminal Rst, the signal line is broken after a buffer Buf13 is passed. A NAND circuit Nand2 has been excluded from the net list by a reduced net list making process as indicated by dotted lines. In such a case that a portion lacking in wiring is reached owing to a trace, the synchronization signal path data producing unit 12a stops the trace and produces synchronization signal path data regarding the path from the flip-flop FF11 to the buffer Buf13.

Incidentally, the result identified by the synchronization signal division identifying unit 14 is the same as identified in a case where no reduced net list is made, e.g., where the synchronization signal path data producing unit 12 runs a trace on the connection in a direction from a clear (CL) terminal which is an input terminal of the flip-flop FF5 to the reset terminal Rst. That is an example of one and the same result identified in cases where the trace is done for a net list and where the trace is done for a reduced net list.

The circuit design assisting device 10a of the third embodiment can have substantially the same effect that the circuit design assisting device 10 of the second embodiment has.

As a reduced net list developed on a memory is smaller in size than an ordinary net list, the synchronization signal path data producing unit 12 of the circuit design assisting device 10a of the third embodiment can carry out a backward-directed trace process rapidly.

Incidentally, the process carried out by the circuit design assisting device 10 or 10a may be divided into and processed by a plurality of devices. One device, e.g., may carry out up to the process for producing the synchronization signal path data and produces the synchronization signal path data, and another device may identify whether the synchronization signal path data is correctly divided on the basis of the synchronization signal path data.

The circuit design assisting device, the method for controlling the circuit design assisting device and the program for controlling the circuit design assisting device of the invention are explained above. The invention is not limited to the above, and the constitution of each of the portions may be replaced with any constitution having substantially the same function. Further, any other constitutions or processes may be added to the invention.

Further, any two or more constitutions included in the respective embodiments described above of the invention may be combined.

Incidentally, the processing functions described above can be implemented by a computer such as a data processing device. In such a case, a program in which what is processed by the functions that the circuit design assisting device 1, 10 or 10a is supposed to have is written is provided. As the computer runs the program, the above processing functions are implemented on the computer. The program in which what is processed can be recorded on a computer-readable recording medium. The computer-readable recording medium is, e.g., a magnetic storage device, an optical disk, a magneto-optical recording medium, a semiconductor memory, etc. The magnetic storage device is, e.g., a hard disk drive (HDD), a flexible disk (FD), a magnetic tape, etc. The magneto-optical recording medium is, e.g., an MO (Magneto-Optical disk), etc.

In order that a program is distributed, e.g., a removable recording medium such as a DVD or a CD-ROM on which the program is recorded is sold. Further, a program stored in a storage device of a server computer can be transferred from the server computer to another computer via a network.

A computer which runs a program stores, e.g., a program recorded on a removable recording medium or a program transferred from a server computer in an own storage device. Then, the computer reads the program from the own storage device and runs a process in accordance with the program. Incidentally, the computer can read the program directly from a removable recording medium and runs a process in accordance with the program. Further, every time receiving a program transferred from a server computer connected to a computer via a network, the computer can successively runs a process in accordance with the received program.

Further, at least part of the above processing functions can be implemented by an electronic circuit such as a CPU (Central Processing Unit), a DSP (Digital Signal Processor), an ASIC (Application Specific Integrated Circuit) or a PLD (Programmable Logic Device).

What is claimed is:

1. A circuit design assisting device for assisting design of a circuit, the circuit design assisting device comprising:
a storage unit that stores circuit connection data of the circuit;
a selecting unit that chooses a storage element that holds a signal inputted from an input terminal based on a clock signal and outputs the signal from an output terminal from the circuit connection data;
a tracing unit that traces a logical connection from the input terminal of the chosen storage element in an opposite direction against propagation of the signal based on the circuit connection data; and
a control unit that suspends the tracing unit to trace the logical connection when the tracing unit reaches to an element having two or more input terminals.

2. The circuit design assisting device according to claim 1, further comprising:
a producing unit that produces reduced circuit connection data by excluding an element having two or more input terminals from the circuit connection data; wherein
the tracing unit traces the logical connection from the input terminal of the chosen storage element in the opposite direction against the propagation of the signal based on the reduced circuit connection data.

3. The circuit design assisting device according to claim 1, wherein the control unit suspends the tracing unit to trace when the tracing unit reaches to an output terminal of a storage element except for the chosen storage element.

4. The circuit design assisting device according to claim 1, further comprising:
a counting unit that counts a number of reached inverters when the tracing unit reaches to an output terminal of a buffer or an inverter; and
an identifying unit that identifies consistency of the traced logical connection based on the counted number of the inverters.

5. The circuit design assisting device according to claim 4, wherein the identifying unit identifies an error in the traced logical connection upon the counted number of the inverters being odd.

6. A method for controlling a circuit design assisting device including a storage unit that stores circuit connection data of the circuit for assisting design of a circuit, the method comprising;
selecting a storage element that holds a signal input from an input terminal based on a clock signal and outputs the signal from an output terminal from the circuit connection data;
tracing a logical connection from the input terminal of the chosen storage element in an opposite direction against propagation of the signal based on the circuit connection data; and
suspending to trace the logical connection when the tracing unit reaches to an element having two or more input terminals.

7. The method for controlling the circuit design assisting device according to claim 6, further comprising:
producing reduced circuit connection data by excluding an element having two or more input terminals from the circuit connection data; wherein
the tracing traces the logical connection from the input terminal of the chosen storage element in the opposite direction against the propagation of the signal based on the reduced circuit connection data.

8. The method for controlling the circuit design assisting device according to claim 6, wherein the suspending suspends tracing when the tracing reaches to an output terminal of a storage element except for the chosen storage element.

9. The method for controlling the circuit design assisting device according to claim 6, further comprising:
counting a number of reached inverters when the tracing unit reaches to an output terminal of a buffer or an inverter; and
identifying consistency of the traced logical connection based on the counted number of the inverters.

10. The method for controlling the circuit design assisting device according to claim 9, wherein the identifying identifies an error in the traced logical connection upon the counted number of the inverters being odd.

11. A non-transitory computer-readable storage medium storing a program for directing a circuit design assisting device including a storage unit that stores circuit connection data of the circuit for assisting design of a circuit to perform a process, the process comprising:
selecting a storage element that holds a signal inputted from an input terminal based on a clock signal and outputs the signal from an output terminal from the circuit connection data;
tracing a logical connection from the input terminal of the chosen storage element in an opposite direction against propagation of the signal based on the circuit connection data; and
suspending to trace the logical connection when the tracing unit reaches to an element having two or more input terminals.

12. The computer-readable storage medium according to claim 11, the process further comprising:
producing reduced circuit connection data by excluding an element having two or more input terminals from the circuit connection data; wherein
the tracing traces the logical connection from the input terminal of the chosen storage element in the opposite direction against the propagation of the signal based on the reduced circuit connection data.

13. The computer-readable storage medium according to claim 11, wherein the suspending suspends tracing when the tracing reaches to an output terminal of a storage element except for the chosen storage element.

14. The computer-readable storage medium according to claim 11, the process further comprising:
counting a number of reached inverters when the tracing unit reaches to an output terminal of a buffer or an inverter; and
identifying consistency of the traced logical connection based on the counted number of the inverters.

15. The computer-readable storage medium according to claim 14, wherein the identifying identifies an error in the traced logical connection upon the counted number of the inverters being odd.
